(19) United States
(12) Patent Application Publication
(10) Pub. No.: US 2024/0142480 A1
(43) Pub. Date: May 2, 2024

(54) AUTOMATED SYSTEM FOR REMOTE CHEMICAL SAMPLE COLLECTION WITH SAFE ISOLATION OF SAMPLE VESSEL

(71) Applicant: Elemental Scientific, Inc., Omaha, NE (US)

(72) Inventors: Caleb Gilmore, Omaha, NE (US); Tyler Yost, Omaha, NE (US); Basanta Bhusal, Omaha, NE (US); Ripudaman Shekhawat, Omaha, NE (US); Kevin Conrad, Omaha, NE (US)

(21) Appl. No.: 17/973,947

(22) Filed: Oct. 26, 2022

Related U.S. Application Data
(60) Provisional application No. 63/276,166, filed on Nov. 5, 2021.

(51) Int. Cl. G01N 35/02; G01N 1/10; G01N 35/10

(52) U.S. Cl. CPC G01N 35/026; G01N 1/10; G01N 35/1004; G01N 2035/0405

(57) ABSTRACT

Systems and methods for safe collection and transportation of fluid samples for analysis are described. A system embodiment includes, but is not limited to, a housing defining an interior region to introduce a fluid sample to a sample vessel; a support platform to hold the sample vessel and laterally position the sample vessel to a plurality of locations within the interior region; an uncapper configured to automatically remove a cap of the sample vessel from a base of the sample vessel prior to introduction of the fluid sample to the base and to automatically replace the cap to the vessel base subsequent to introduction of the fluid sample to the base; and a fluid sample probe configured to fluidically couple with a fluid sample source and to dispense fluid from the fluid sample source into the vessel base.

### CROSS-REFERENCE TO RELATED APPLICATIONS

The present application claims the benefit of 35 U.S.C. § 119(e) of U.S. Provisional Application Ser. No. 63/276,166, filed Nov. 5, 2021, and titled “AUTOMATED SYSTEM FOR REMOTE CHEMICAL SAMPLE COLLECTION WITH SAFE ISOLATION OF SAMPLE VESSEL.” U.S. Provisional Application Ser. No. 63/276,166 is herein incorporated by reference in its entirety.

### BACKGROUND

In many laboratory settings, it is often necessary to analyze a large number of chemical or biochemical samples at one time. In order to streamline such processes, the manipulation of samples has been mechanized. Such mechanized sampling is commonly referred to as autosampling and is performed using an automated sampling device or autosampler.

Sample introduction systems may be employed to introduce liquid samples into ICP spectrometry instrumentation (e.g., an Inductively Coupled Plasma Mass Spectrometer (ICP/ICP-MS), an Inductively Coupled Plasma Atomic Emission Spectrometer (ICP-AES), or the like) for analysis. For example, a sample introduction system may withdraw an aliquot of a liquid sample from a container and thereafter transport the aliquot to a nebulizer that converts the aliquot into a polydisperse aerosol suitable for ionization in plasma by the ICP spectrometry instrumentation. The aerosol is then sorted in a spray chamber to remove the larger aerosol particles. Upon leaving the spray chamber, the aerosol is introduced into the plasma by a plasma torch assembly of the ICP-MS or ICP-AES instruments for analysis.

### SUMMARY

Systems and methods for safe collection and transportation of fluid samples for analysis are described to avoid exposure of hazardous materials to personnel during collection and transfer of samples to laboratory processing equipment. A system embodiment includes, but is not limited to, a housing defining an interior region to introduce a fluid sample to a sample vessel; a support platform to hold the sample vessel and laterally position the sample vessel to a plurality of locations within the interior region; an uncapper configured to automatically remove a cap of the sample vessel from a base of the sample vessel prior to introduction of the fluid sample to the base and to automatically replace the cap to the vessel base subsequent to introduction of the fluid sample to the base; and a fluid sample probe configured to fluidically couple with a fluid sample source and to dispense fluid from the fluid sample source into the vessel base.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### FIGURES

The Detailed Description is described with reference to the accompanying figures. The use of the same reference numbers in different instances in the description and the figures may indicate similar or identical items.

FIG. 1 is an isometric view of a system for automated, safe sample collection from a remote sample source in accordance with example implementations of the present disclosure.

FIG. 2 is an isometric view of a system for automated, safe sample collection from a remote sample source having multiple sampling stations in accordance with example implementations of the present disclosure.

FIG. 3 is a partial side view of the system of FIG. 1.

FIG. 4A is an isometric view of the system of FIG. 1, showing a sample vessel interacting with a scanner in accordance with example implementations of the present disclosure.

FIG. 4B is a partial isometric view of the system of FIG. 2.

FIG. 4C is a schematic diagram of a communication system including a system for automated, safe sample collection from a remote sample source in accordance with example implementations of the present disclosure.

FIG. 5A is an isometric view of the system of FIG. 1, shown with a sample vessel in a load configuration.

FIG. 5B is a partial top view of the system of FIG. 5A.

FIG. 6A is an isometric view of the system of FIG. 1, shown with a sample vessel in a wash configuration.

FIG. 6B is a partial top view of the system of FIG. 6A.

FIG. 7A is a partial side view of the system of FIG. 1, shown with a sample vessel in a capping configuration.

FIG. 7B is a partial top view of the system of FIG. 7A.

FIG. 7C is a partial side view of an uncapper interacting with a cap of a sample vessel in accordance with example implementations of the present disclosure.

FIG. 8A is a partial side view of the system of FIG. 1, shown with a sample vessel in a sample fill configuration.

FIG. 8B is a partial top view of the system of FIG. 8A.

FIG. 9 is a partial isometric view of a sample platform in a sample receipt configuration in accordance with example implementations of the present disclosure.

FIG. 10A is a partial isometric view of a sample vessel supported by a sample platform incorporating magnetic load compensation structures in accordance with example implementations of the present disclosure.

FIG. 10B is a partial side view of the sample vessel supported by the sample platform of FIG. 10A.

### DETAILED DESCRIPTION

### Overview

Often in laboratory or industry settings, large numbers of samples are analyzed. Autosamplers are frequently used to gather and introduce samples for subsequent testing of the composition of these samples. Using an autosampler typically allows more samples and other solutions to be prepared and tested as compared to manual preparation methods. Determination of trace elemental concentrations or amounts in a sample can provide an indication of purity of the sample, or an acceptability of the sample for use as a reagent, reactive component, or the like. For instance, in certain production or manufacturing processes (e.g., mining, metallurgy, semiconductor fabrication, pharmaceutical processing, etc.), the tolerances for impurities can be very strict, for example, on the order of fractions of parts per billion. For example, semiconductor processes can require ultralow detection limits for impurities in process chemicals including, but not limited to, ultrapure water (UPW) for washing wafers, isopropyl alcohol (IPA) for drying wafers, hydrogen peroxide (H₂O₂), ammonia solution (NH₄OH), acids and other etching chemicals, and the like. Failure to detect ultralow concentrations of impurities in such process chemicals can ruin a semiconductor wafer, such as by precipitating such impurities out of solution and onto the wafer (e.g., depositing a metallic impurity or other conductivity hazard onto the wafer, such as through precipitation of the impurity out of solution, the wafer acting as a concentrator surface for the impurity, or the like).

Processes for gathering samples for analysis can vary depending on the type of sample, the location of a sample, the location of testing equipment, personnel involved, and the like. Oftentimes individuals (e.g., factory or laboratory technicians or other personnel) are trained to manually gather a sample into a sample vessel, such as a test tube or bottle, and transport the sample to a laboratory or other location for analysis. For many locations (e.g., factories, fabrication facilities, chemical plants, etc.), the source of a sample may be located relatively far away from analytic instrumentation used to test the sample. For example, a chemical supply line in a factory may be positioned in a separate area of the factory from an on-site or off-site laboratory that houses the equipment used to monitor the composition of the chemicals. However, each interaction between personnel and a sample poses health risks to the individual, contamination risks to the sample, and exposure risks to the area traversed by the sample. For instance, an individual could be exposed to hazardous chemicals during the transfer of a sample from its origin into a sample vessel (e.g., spilling or other exposure during a pressurized fluid transfer), a sample vessel can expose hazardous chemicals to an environment and personnel within it if not adequately sealed or otherwise isolated, etc.

Additionally, the safety of others involved with the sample handling can depend on other personnel who previously handled the sample container. For example, a laboratory technician could be exposed to dangerous residue present on an exterior surface of a sample container if the sample was mishandled during sample gathering or transfer (e.g., without rinsing the container).

In addition to the physical risks associated with mishandling of samples, manual sampling processes can introduce risk of improper identification of a sample. Mislabeling or misidentifying a sample during or after transit from a sampling point can cause information associated with the sample to be erroneously associated with another sample, such as through misplacement of the sample container within a sample rack, misplacement of a sample within a particular sample container, or the like. The ordering of the various containers available to an autosampler can affect the accuracy of data generated from analysis of the samples contained therein. For instance, autosampling systems can rely on a specific or predetermined arrangement of sample containers held within a sample rack while the probe is introduced to each sample container in a serial manner. Results of the analysis of the samples are then tied to the specific or predetermined arrangement following the serial progression. As such, the results of such analysis can be erroneous if an individual deviates from the specific or predetermined arrangement when placing sample containers in the sample rack(s). The risk of error can increase if the individual placing samples at the autosampler differs from the individual handling the initial gathering of the sample.

Further, manual sample techniques can involve risk of introduction of a sample into a bottle or other vessel that is composed of material unsuitable for containing the materials present in the sample. For example, a sample containing concentrated acid could be dispensed into a plastic-based container, which can be dissolved by the sample, thereby introducing contaminants into the sample that are not present in the sample originally (e.g., at the sample point).

Accordingly, systems and methods for safe collection and transportation of fluid samples for analysis are described having automated sample filling stations to avoid exposure of hazardous materials to personnel during collection and transfer of samples to laboratory processing equipment. A system embodiment includes an automated filling station to receive a sample vessel (e.g., a sample bottle, tube, or other fluid container), wash an exterior surface of the sample vessel, remove a cap from the sample vessel, introduce a fluid sample into an interior of the sample vessel, return the cap to the sample vessel, and release the filled sample vessel for conveyance by a user. In example implementations, the filling station incorporates a scanning device to scan one or more identifiers present on the sample vessel to determine whether the sample vessel is an appropriate container to hold the fluid dispensed by the filling station. Upon confirmation of an appropriate container, the filling station can automatically transport the sample vessel within an environmentally-isolated interior chamber to remove the cap, fill the sample vessel with sample, return the cap, rinse the sample vessel (with an optional pre-fill rinse), and release the sample vessel for conveyance by a user while ensuring the sample does not substantially dissolve or otherwise damage the sample vessel.

By isolating the sample vessel within the filling station during filling procedures and providing automated rinse procedures, the system prevents exposure of hazardous materials to personnel during filling of the sample vessel and transfer of the sample from the sampling site to a laboratory for analysis. The filling station automates the uncapping, capping, rinsing, and filling operations to avoid any manual sample dispensing by an individual (e.g., via manual manipulation of valve) and to avoid any manual opening or closing of caps or lids on the sample vessels.

### Example Implementations

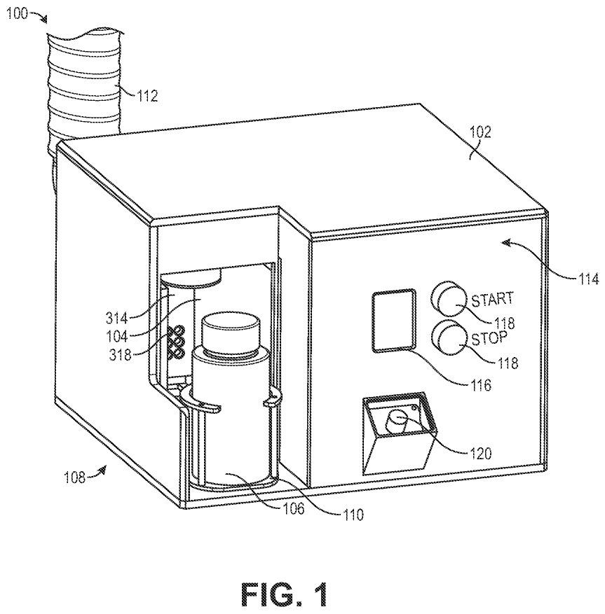

FIG. 1 illustrates a system 100 for safe, automated collection of fluid samples in accordance with an example implementation of the present disclosure. The system 100 generally includes a housing 102 defining an interior region 104 in which a sample can be dispensed into a sample vessel (e.g., sample bottle 106 is shown) while isolating the sample vessel from an external environment 108 in which the system 100 is located and from personnel using the system 100. For example, the system 100 can be located at a fluid source remote from a laboratory or analysis equipment used to identify chemical analytes within the sample, such as within an industrial facility, fabrication facility, chemical processing facility, or the like. The system 100 includes a sample platform 110 to support and transport the sample vessel within the system 100 to facilitate introduction of a fluid sample to the sample vessel. For example, the sample platform 110 can transition between two or more positions to transport the sample vessel between various positions within the system 100 including, but not limited to, a sample vessel receiving position, a rinse position, a capping position, and a sample fill position, each of which are described further herein. An exhaust 112 can be coupled with the interior region 104 to vent gases from the interior region 104 while containing the gases to avoid exposure to the external environment 108.

The system 100 can also include user interface components that facilitate automatic operation of the sampling procedure. For example, the system 100 is shown in FIG. 1 as including a user interface 114 including a display screen 116 to provide operational information to a user and operation input buttons 118 to permit a user to engage with the system 100, such as to start a sampling procedure, stop operation of the system 100, and so forth. While the user interface 114 is shown in an example implementation as including the display screen 116 with separate input buttons 118, the system 100 is not limited to such configuration and can include integrated touch screen features for the display screen 116, communication interfaces to provide control features of the system 100 from a portable user device (e.g., mobile phone, tablet, computer, or the like), or other user interface configurations.

The system 100 is further shown including a scanner 120 to recognize a bottle identifier positioned on the sample bottle 106. For example, the scanner 120 can include an optical scanner, such as a camera, bar code scanner, or the like, to image or scan a bottle identifier, such as a barcode, a data matrix two-dimensional (2D) barcode, an RFID tag, or other identifier. The bottle identifier can provide various information about the sample bottle 106 or samples to be included in the sample bottle 106 (e.g., via communication of the system 100 with an information database) including, but not limited to, a material from which the sample bottle 106 is constructed, types of samples suitable for use with the sample bottle 106, types of samples unsuitable for use with the sample bottle 106 (e.g., chemicals that pose a risk for dissolving the material of the sample bottle 106), a cleanliness status of the sample bottle 106 (e.g., whether the sample bottle 106 has been sanitized, washed, rinsed, or otherwise cleaned), or the like. For example, in implementations, the system 100 can prevent a sampling procedure from starting if the sample bottle 106 includes an identifier that indicates the sample bottle 106 is unsuitable for holding the particular sample available at the system 100, such as if the material of the sample bottle 106 could dissolve through exposure to the sample or if the sample bottle 106 is not in a cleaned state (e.g., the sample could be contaminated if introduced to the particular sample bottle 106). While the scanner 120 is shown coupled to an external portion of the housing 102, the system 100 is not limited to such configuration and can include the scanner 120 or additional scanners 120 at a different position of the system 100, including, but not limited to within the interior region 104, on the sample platform 110, or at another position to scan the bottle identifier.

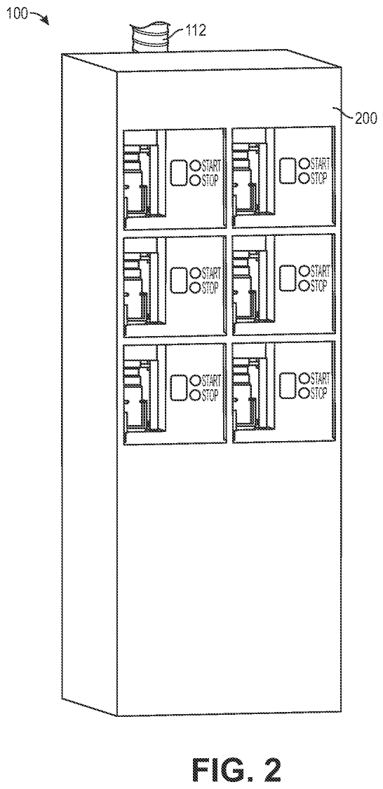

The system 100 is shown in FIG. 1 as a single sample dispensing station having a single exhaust 112 to vent gases from the interior region 104, however the system 100 is not limited to a single sample dispensing station and can include a plurality of sample dispensing stations. For example, the system 100 is shown in FIG. 2 as including six sample dispensing stations supported by a common housing 200. The housing 200 can include connections to vent gases from each of the sample dispensing stations to a common exhaust 112 or through individual exhaust pathways. By including a plurality of sample dispensing stations, the system 100 can facilitate multiple different chemical sampling sites to dispense a plurality of different chemicals, to dispense a plurality of samples of the same chemical simultaneously (e.g., to increase throughput of sampling as compared to a single sample dispensing station), or combinations thereof.

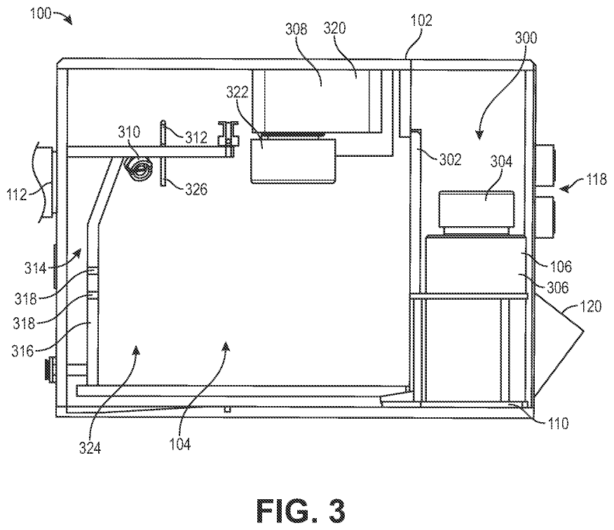

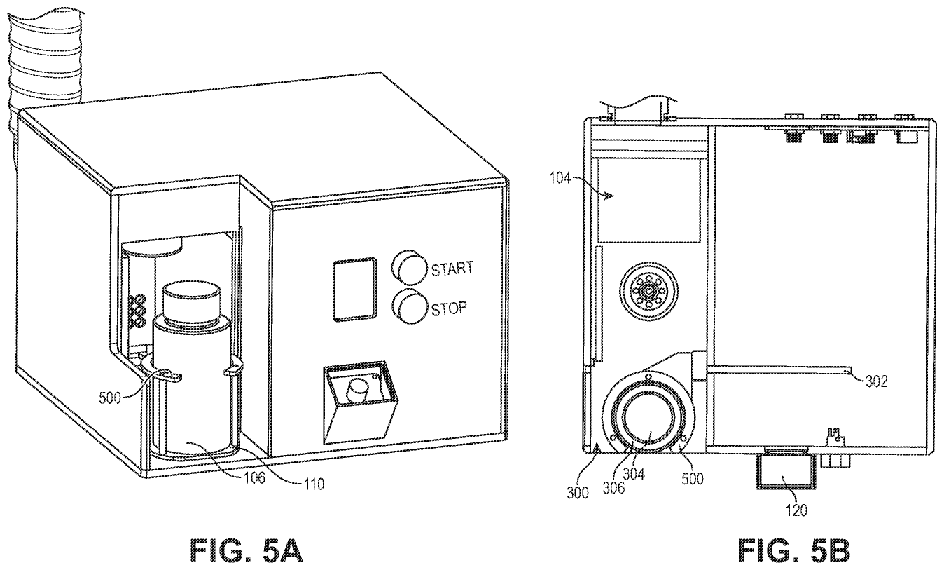

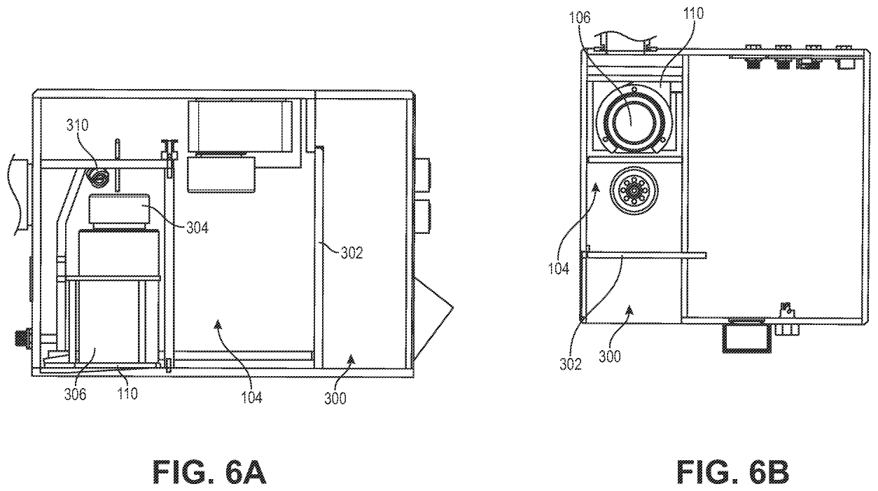

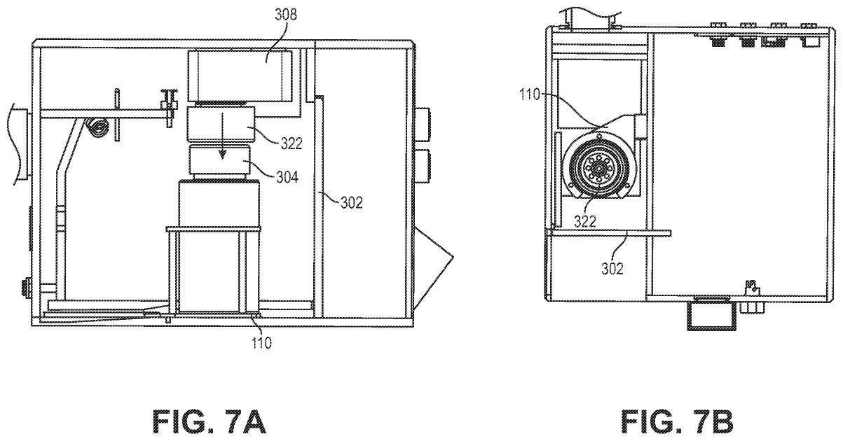

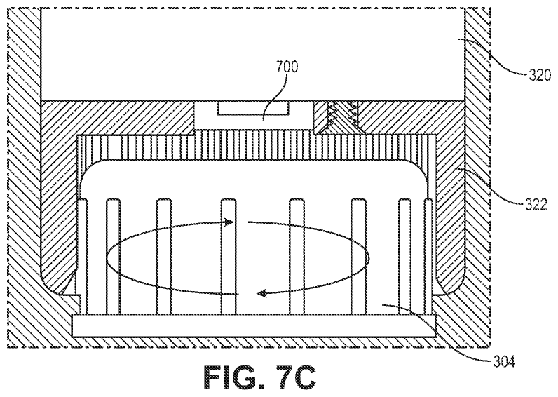

Referring to FIG. 3, a side view of the system 100 is provided, with components positioned within the interior region 104 that facilitate the sampling procedure being shown. The system 100 is shown with the sample platform 110 positioned outside the interior region 104 at a sample vessel receiving portion 300 of the system 100 to receive the sample bottle 106 from the user. In implementations, the system 100 includes a door 302 that can slidably transition between an open configuration (e.g., as shown in FIGS. 3, 5A, and 5B) and a closed configuration (e.g., as shown in FIGS. 6A-7B) to separate the interior region 104 from the sample vessel receiving portion 300. For instance, when the door 302 is in the open configuration, the sample platform 110 can transfer the sample bottle 106 from the sample vessel receiving portion 300 into the interior region 104, and when the door 302 is in the closed configuration, the door 302 seals the interior region 104 from the sample vessel receiving portion 300 and the external environment 108 (e.g., to prevent potentially hazardous sample or gases from exiting the interior region 104). Other transitions between the open configuration and the closed configuration can be implemented, for example, by rotating the door 302, lifting the door 302, or the like. While the sample bottle 106 is in the sample vessel receiving portion 300, a bottle cap 304 positioned on a bottle base 306 can separate an interior of the sample bottle 106 from the external environment 108 (e.g., to prevent contaminants from the external environment 108 from entering into the interior of the sample bottle 106 before a fluid sample is introduced to the sample bottle 106).

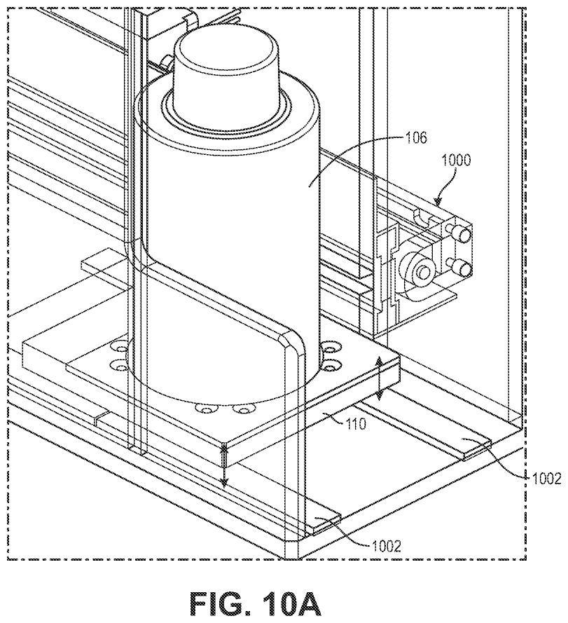

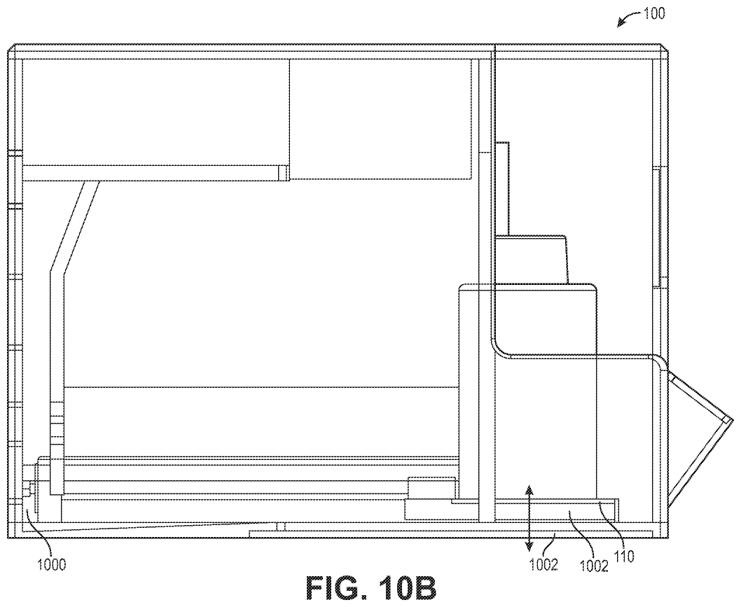

The interior region 104 of the system 100 generally includes the portions of the system 100 that interact with the sample bottle 106 to prepare the sample bottle 106 for receiving the fluid sample without manual action by the user. For example, FIG. 3 shows the interior region 104 including an uncapper 308 configured to interact with the bottle cap 304 to remove from and replace onto the bottle base 306, a rinse nozzle 310 configured to wash the sample bottle 106 (e.g., prior to filling with sample, subsequent to filling with sample, or combinations thereof), a sample fluid probe 312 configured to introduce the fluid sample to the sample bottle 106, and an exhaust channel 314 coupled between the exhaust 112 and the interior region 104 to direct gases out of the interior region 104 for removal from the system 100. The sample platform 110 can position the sample bottle 106 relative to portions of the interior region 104 to facilitate the sampling procedure. In implementations, the sample platform 110 is coupled to a motor secured in the housing 102 separate from the interior region 104 to move the sample platform 110 in a linear motion through the interior region 104 (e.g., as shown in FIGS. 10A and 10B). For example, the motor can include a worm gear coupled to the sample platform 110 to permit rotation of the worm gear to translate to linear motion of the sample platform, however the system 100 is not limited to such motor configurations.

In implementations, the exhaust channel 314 is defined at least partially by a divider wall 316 that separates the interior region 104 from the exhaust channel 314, such as to prevent the sample bottle 106 from entering the exhaust channel 314 while permitting passage of gases through one or more apertures 318 defined by the divider wall 316. A low pressure or negative pressure source can be coupled to the exhaust 112 to draw air and other gases from the system 100 with the exhaust channel 314.

In implementations, the uncapper 308 includes an uncapper housing 320 coupled with a rotating uncapper head 322 to interface with the bottle cap 304. During operation of the system 100, the sample platform 110 positions the sample bottle 106 beneath the uncapper 308 in an uncapping position (e.g., shown in FIGS. 7A and 7B). The uncapper 308 can then lower the uncapper head 322 onto the bottle cap 304. In implementations, the uncapper housing 320 supports a motor or pneumatic drive to provide vertical movement of the uncapper head 322 to move downwards onto the bottle cap 304 and upwards from the sample bottle 106 following uncapping. Alternatively or additionally, the uncapper head 322 can define one or more apertures into which the bottle cap 304 can pass during movement of the sample bottle 106 from the sample vessel receiving portion 300 to the uncapper 308. The motor also provides rotational movement of the uncapper head 322 to rotate the bottle cap 304 relative to the bottle base 306 to permit removal of the bottle cap 304 from the bottle base 306 (e.g., when the bottle cap 304 and the bottle base 306 are secured relate to each other via a threaded configuration).

In implementations, the uncapper head 322 includes a vacuum nozzle to hold the bottle cap 304 within the uncapper head 322 while the uncapper head 322 is lifted vertically from the bottle base 306 to provide an uncapped bottle base, where the sample platform 110 can move the uncapped bottle base while the uncapper head 322 supports the bottle cap 304 for later replacement onto the bottle base 306. While the uncapper head 322 has been described as rotationally driven, the system 100 can include alternative or additional uncapper structures, dependent on the structure of the sample vessel used to hold the fluid sample. For example, the uncapper head 322 could be configured to slide, lift, hinge, or provide other motions to a lid supported by the bottle base 304 to provide access to the interior of the bottle base 304 to the sample probe 312. Alternatively or additionally, portions of the sample platform 110 can be configured to move relative to the uncapper 308, such as by rotating the bottle base 306 while the uncapper head 322 is held stationary or rotated in an opposite direction.

The rinse nozzle 310 is fluidically coupled with a rinse fluid source (e.g., ultrapure water, deionized water, etc.) to clean the sample bottle 106 prior to sample introduction, subsequent to sample introduction, or both. For example, the sample platform 110 can position the sample bottle 106 adjacent the rinse nozzle 310 to permit spraying of rinse fluid from the rinse nozzle 310 onto the sample bottle 106. When the rinse nozzle 310 is used to clean the sample bottle 106 prior to sample introduction, the system 100 can maintain the bottle cap 304 on the bottle base 306 to remove any residual contaminants present on the exterior of the sample bottle 106 (e.g., acquired during transit of the sample bottle 106 to the system 100 by the user) to avoid introduction of any of the contaminants into the interior of the sample bottle 106 during the sample fill procedure.

When the rinse nozzle 310 is used to clean the sample bottle 106 subsequent to sample introduction, the system 100 can rinse any sample fluid that may have splashed, spilled, or otherwise deposited on the external surfaces of the sample bottle 106 during the sample fill procedure. Such a post-fill rinse procedure can prevent contact between the residual fluid and the user that will remove the filled sample bottle 106 from the system 100. In implementations, the rinse nozzle 310 is positioned at a rear portion 324 of the interior region 104 between the uncapper 308 and the exhaust channel 314, however the system 100 can include the uncapper 308, the rinse nozzle 310, and the sample probe 312 in any position without departing from the scope of the present disclosure. The system 100 can include a drain port to remove rinse fluid and any contaminants from the interior region 104.

The sample fluid probe 312 is configured to dispense the sample fluid into the bottle base 306 when the sample platform 110 positions the bottle base 306 adjacent the sample fluid probe 312. For example, the sample fluid probe 312 can be fluidically coupled with a pressurized sample fluid source, such as a pressurized fluid line, a fluid pump, or the like, to dispense the fluid sample. In implementations, the system 100 can vertically position the sample fluid probe 312 (e.g., between a raised position and a lowered position) to control positioning of a dispensing end 326 with respect to the bottle base 306. For example, the lowered position can place the dispensing end 326 into the interior of the bottle base 306, which can help prevent splashing of the sample fluid onto an exterior surface of the sample bottle 106. In implementations, the system 100 maintains the sample fluid probe 312 in the raised position prior to sample filling, which permits passage of the bottle base 306 beneath the dispensing end 326 during transit of the bottle base 306 adjacent the sample fluid probe 312 via the sample platform 110. When the sample platform 110 positions the bottle base 306 adjacent the sample fluid probe 312 (e.g., underneath the sample fluid probe 312), the system 100 can lower the sample fluid probe 312 to introduce the dispensing end 326 into the interior of the bottle base 306 prior to dispensing the sample fluid from the sample fluid probe 312.

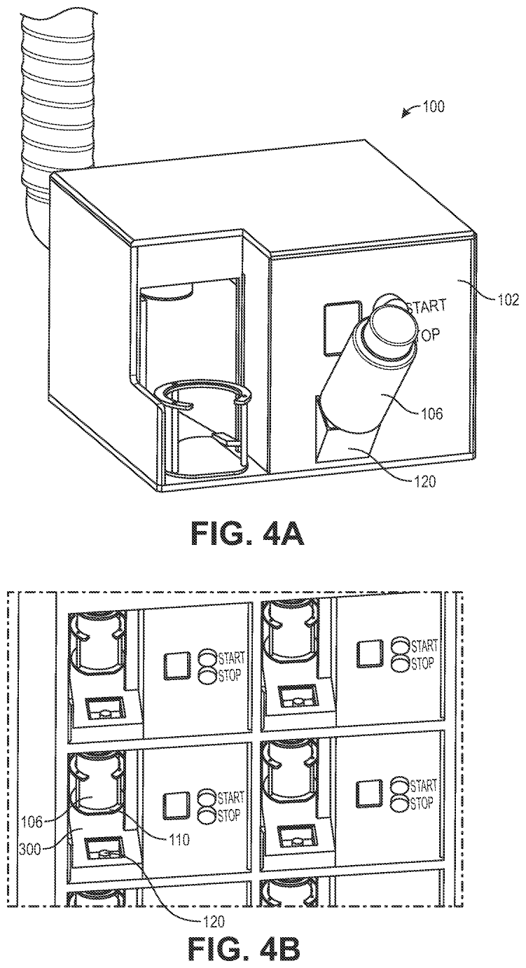

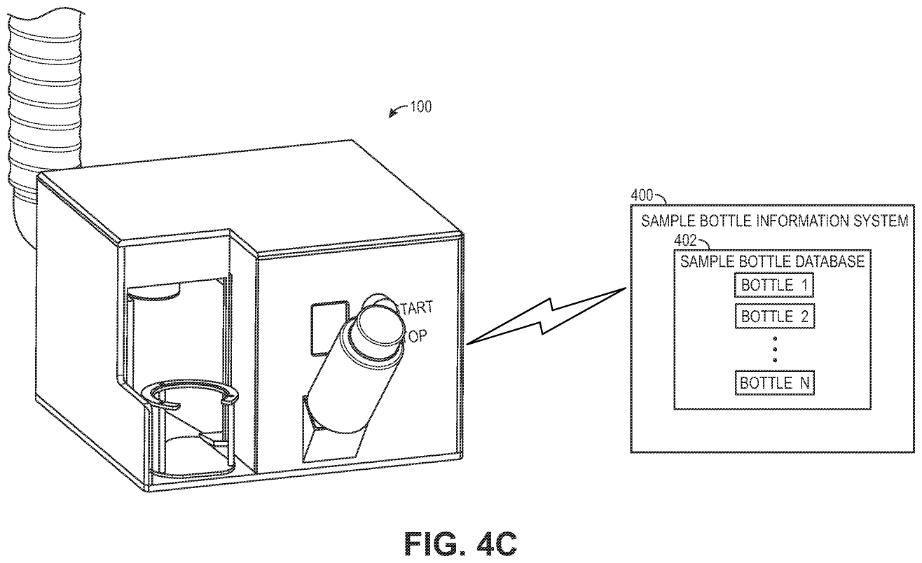

An example filling procedure is described with reference to FIGS. 4A through 8B in accordance with example implementations of the present disclosure. The filling procedure begins with the sample bottle 106 being scanned by the scanner 120 to identify the sample bottle 106, such as to determine whether the sample bottle 106 is in a condition suitable for receiving the fluid sample for subsequent chemical analyte determinization by an analytic system (e.g., via an inductively-coupled plasma spectroscopy system, such as ICPMS, or other detection/analysis system). The system 100 in FIG. 4A illustrates the scanner 120 positioned on an exterior region of the housing 102, where the user can pass the sample bottle 106 over to scan the identifier positioned on the sample bottle 106 (e.g., on a bottom surface of the bottle base 306). The system 100 in FIG. 4B illustrates the scanner 120 positioned in the sample vessel receiving portion 300, such that the scanner 120 can scan the identifier positioned on the sample bottle 106 while the sample bottle 106 is positioned on the sample platform 110, during insertion of the sample bottle 106 onto the sample platform 110, during movement of the sample platform 110 to a position within the interior region 104, or the like, or combinations thereof.

In implementations, the system 100 includes or is communicatively coupled with an information database to monitor and track the status of a given sample bottle 106 based on the identifier to determine whether the sample bottle 106 is in a condition suitable for receiving the fluid sample and to automatically process the sample bottle 106 according to preset operational standards associated with the identifier. For example, referring to FIG. 4C, the system 100 is communicatively coupled with a sample bottle information system 400 that maintains a sample bottle database 402 to track the status of a plurality of sample bottles. The sample bottle database 402 can associate a variety of information with a given identifier, including but not limited to, a bottle size, a bottle material, a bottle wash status (e.g., has the bottle been cleaned/sterilized), a bottle storage location, names of individuals having handled the bottle, previous locations of the bottle, previous fluids held by the bottle, volume of sample to dispense into the bottle, and the like. When the sample bottle 106 is determined to be in a condition suitable for receiving the fluid sample (e.g., the sample bottle 106 is formed from a material that is not at risk for being dissolved by the sample fluid, has a wash status indicating a washed interior, etc.), then the system 100 can permit the sampling procedure to begin when the user interacts with the input buttons 118. Alternatively or additionally, the system 100 can recognize of the presence of the sample bottle 106 on the sample platform 110 (e.g., via one or more optical sensors) to ensure the sample bottle 106 is in the system 100 ready for receiving the fluid sample.

In implementations, the system 100 transmits information to the sample bottle information system 400 based on activity of the system 100 involving the particular sample bottle 106. For example, the system 100 can transmit a filled status for the identifier associated with the sample bottle 106 to be stored in the sample bottle database 402 following the automated filling procedure described herein. Data managed by the sample bottle information system 400 can be made available to various locations that can access the sample bottle information system 400 to provide information about the sample bottle 106 (and other bottles handled by the system 100). For example, a scanner associated with the analytic system (e.g., an inductively-coupled plasma spectroscopy system, such as ICPMS) can scan the identifier on the sample bottle 106 and access information via the sample bottle information system 400 to provide updated information associated with the sample bottle 106 as updated by the system 100 (e.g., upon sample fill) to provide information about the particular fluid sample contained in the sample bottle 106 including but not limited to, sample type, sample source, sample date, personnel who obtained sample via system 100, and so forth.

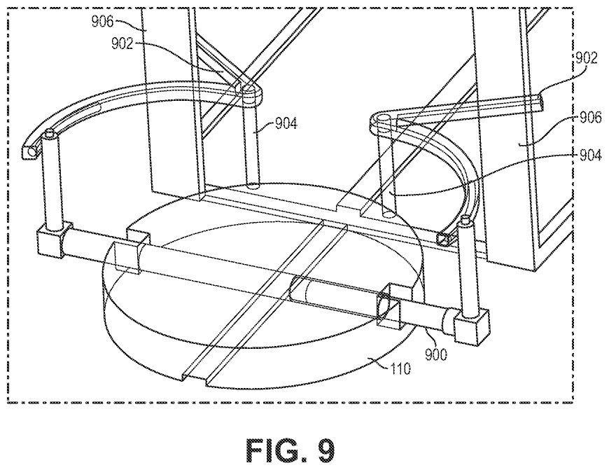

Referring to FIGS. 5A and 5B, the system 100 is shown with the sample bottle 106 positioned on the sample platform 110 in the sample vessel receiving portion 300. The sample bottle 106 includes the bottle cap 304 secured to the bottle base 306 on the sample platform 110. The door 302 is shown in the open configuration to permit the sample platform 110 to transfer the sample bottle 106 from the sample vessel receiving portion 300 to the interior portion 104. In implementations, the sample platform 110 includes one or more support arms 500 to hold the sample bottle 106 securely on the sample platform 110. In implementations, an example of which is shown in FIG. 9, the support arms 500 are configured to open automatically upon extension of the sample platform 110 outwards from the system 100 beyond the sample vessel receiving portion 300. The support arms 500 can include a tensioned coupler 900 (e.g., a spring-loaded coupler) that bias the support arms 500 in a closed position which bring the support arms 500 together to hold the sample bottle 106 on the sample platform 110 (e.g., as shown in FIGS. 5A and 5B). The support arms 500 can also include wings 902 rotatably coupled to the sample platform 110 via posts 904. As the sample platform 110 is extended outwards (e.g., via motor action), the wings 902 can contact housing portions 906 to rotate the support arms 500 into an opened configuration (e.g., shown in FIG. 9) by overcoming the bias applied by the tensioned coupler 900. When the sample bottle 106 is placed on the sample platform 110, the sample platform 110 can retract into the sample vessel receiving portion 300 where the tensioned coupler 900 can pull the support arms 500 back into the closed configuration.

Following placement of the sample bottle 106 on the sample platform 110, the sample platform can position the sample bottle 106 within the interior portion 104 and the system 100 can close the door 302 to isolate the interior portion 104 from the external environment 108. If a pre-fill rinse procedure is desired, the sample platform can convey the sample bottle 106 to the rinse position adjacent (e.g., underneath) the rinse nozzle 310. For example, referring to FIGS. 6A and 6B, the system 100 is shown with the sample bottle 106 with the bottle cap 304 secured to the bottle base 306 and positioned on the sample platform 110 within the interior portion 104 adjacent the rinse nozzle 310. The system 100 can then introduce rinse fluid from the rinse nozzle 310 onto the exterior of the sample bottle 106, such as by engaging a fluid pump, opening a flow valve, or otherwise permitting pressurized fluid to eject from the rinse nozzle 310. Following rinsing, the system 100 can dry the sample bottle 106, such as through application of an inert gas (e.g., nitrogen gas), heating, or combinations thereof. For example, the system 100 can include an inlet port to introduce a gas into the interior portion 104 to dry the sample bottle 106, where the gas can be withdrawn via the exhaust 112. If a pre-fill rinse procedure is not desired, then the sample bottle can be conveyed to the uncapper 308 without a pre-fill rinse occurring.

Referring to FIGS. 7A and 7B, the system 100 is shown with the sample platform 110 positioning the sample bottle 106 adjacent (e.g., underneath) the uncapper 308 to permit interaction between the uncapper 308 and the sample bottle 106. For instance, prior to introduction of sample fluid to the bottle base 306, the uncapper can remove the bottle cap 304 from the bottle base 306 through interaction between the uncapper head 322 and the bottle cap 304. During the uncapping procedure, the door 302 can remain in the closed configuration to prevent contaminates from the external environment 108 from entering the interior region 104 and into the exposed interior of the bottle base 306.

Interaction between the uncapper head 322 and the bottle cap 304 is shown in an example implementation in FIG. 7C. As shown, the uncapper head 322 defines an interior region into which at least a portion of the bottle cap 304 fits to provide physical interaction between an interior surface of the interior region and an exterior surface of the bottle cap 304. For example, the uncapper head 322 can include one or more protrusions, ridges, surface features or the like that correspond to or physically interact with an outer surface of the bottle cap 304, one or more protrusions, ridges, surface features or the like of the bottle cap 304, and combinations thereof. In implementations, the uncapper housing 320 supports a motor to provide rotation of the uncapper head 322, where rotation of the uncapper head 322 provides a corresponding rotation of the bottle cap 304 to loosen the bottle cap 304 relative to the bottle base 306. A user can set a maximum torque value to be applied to the bottle cap 304 (e.g., via a user interface communicatively coupled with the system 100) to prevent rotation of the bottle cap 304 upon achieving a torque that meets or exceeds the maximum torque value. For example, the system 100 can include a torque sensor (e.g., coupled to the uncapper 308) to monitor the torque applied to the bottle cap 304, where upon sensing a torque that meets or exceeds the maximum torque value, the system 100 ceases rotation of the uncapper head 322 (e.g., to prevent damage to the bottle base 306, the bottle cap 304, etc.).

In implementations, the uncapper 308 includes a vacuum structure 700 positioned within the uncapper head 322 to draw a vacuum against the bottle cap 304 to hold the loose bottle cap 304 within the uncapper head 322. For example, the vacuum structure 700 can hold the loose bottle cap 304 within the uncapper head 322 during an upward motion of the uncapper 308 to remove the bottle cap 304 from the bottle base 306. The uncapper 308 can then position the removed bottle cap 304 away from the bottle base 306 to provide access to the interior of the bottle base 306 by the sample fluid probe 312. In implementations, the uncapper 308 includes a vacuum sensor configured to register the presence of the bottle cap 304 relative to the uncapper head 322, the absence of the bottle cap 304 relative to the uncapper head 322, or combinations thereof. The vacuum sensor can generate a sense signal to indicate the presence or absence of the bottle cap 304 to provide information to the system 100 regarding a status of the bottle cap 304 (e.g., tightened, loosened, in place on the bottle base 306, vertically positioned above the bottle base 306, rotated or otherwise positioned away from the bottle base 306, etc.). For example, the sense signal can be sent to the a system controller to control aspects of the system 100 based upon the status of the bottle cap 304, such as to prevent fluid flow from the sample fluid probe 312 if the bottle cap 304 is not present at the uncapper 308 (e.g., to prevent dispensing fluid if the fluid cannot reach the interior of the bottle base 306 with the bottle cap 304 on the bottle base 306 or the sample bottle 106 not present on the sample platform 110).

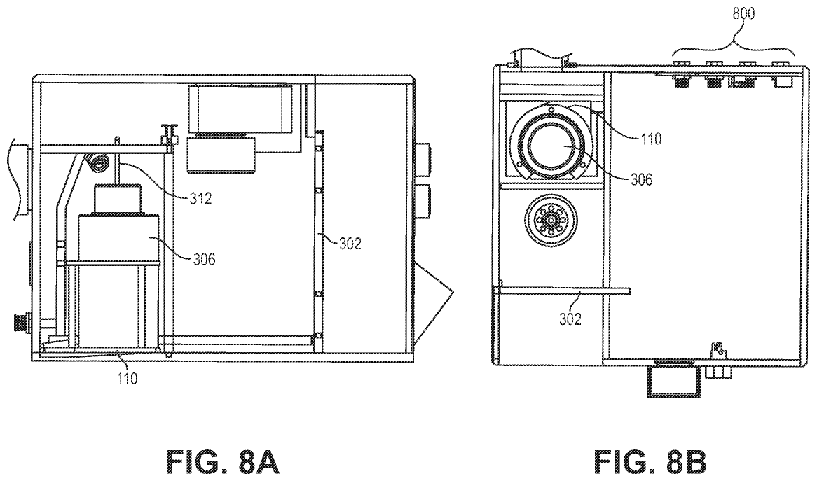

Following removal of the bottle cap 304 from the bottle base 306, the system 100 can position the bottle base 306 for filling with the fluid sample. For example, referring to FIGS. 8A and 8B, the system is shown with the bottle base 306 on the support platform 110 adjacent the sample fluid probe 312. In implementations, prior to dispensing of the fluid sample from the sample fluid probe 312, the system 100 lowers the sample fluid probe 312 into the interior of the bottle base 306 such that at least a portion of the dispensing end 326 is inside the interior of the bottle base 306. Sample fluid can be introduced to the system 100 via one or more fluid ports 800 in the housing 102. In implementations, the system 100 automatically dispenses a volume of fluid sample dependent on the identifier on the sample bottle 106, where such volume can be stored and retrieved from the sample bottle information system 400. By associating the desired volume with the identifier on the sample bottle 106, the system 100 can ensure that an appropriate amount of sample is dispensed into an appropriate sample bottle 106, without risk of overflow or insufficient sample being present.

Following filling of the bottle base 106, the sample platform 110 can position the bottle base 106 adjacent the uncapper 308 to permit the uncapper 308 to replace the bottle cap 304 previously removed (e.g., by reversing the uncapping procedure). With the bottle cap 304 replaced, the system 100 can perform a post-fill rinse operation, such as described with respect to a pre-fill rinse operation illustrated in FIGS. 6A and 6B, with optional subsequent drying, to prevent any splashed or overflowed fluid from being on the external surface of the sample bottle 106.

Referring to FIGS. 10A and 10B, an example configuration of the sample platform 110 is shown. The sample platform 110 is shown extending from a motor 1000 (e.g., a worm gear drive) to provide linear motion of the sample platform 110 through the system 100. The sample platform 110 can include magnetic load compensation structures 1002 to compensate for large forces experienced by the sample platform 110 when the sample bottle 106 is filled. For example, the magnetic load compensation structures 1002 can include rails of opposing magnetic fields on a bottom surface of the sample platform and a top surface of the portion of the housing 102 on which the sample platform is supported.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An automated sample fluid collection system, comprising:
a housing defining an interior region to introduce a fluid sample to a sample vessel;
a support platform to hold the sample vessel and laterally position the sample vessel to a plurality of locations within the interior region;
an uncapper positioned within the interior region and configured to automatically remove a cap of the sample vessel from a base of the sample vessel prior to introduction of the fluid sample to the base and to automatically replace the cap to the vessel base subsequent to introduction of the fluid sample to the base; and
a fluid sample probe configured to fluidically couple with a fluid sample source and to dispense fluid from the fluid sample source into the vessel base.

2. The automated sample fluid collection system of claim 1, further comprising a rinse nozzle within the interior region, the rinse nozzle configured to dispense a rinse fluid onto an external surface of the sample vessel.

3. The automated sample fluid collection system of claim 1, further comprising a motor coupled with the support platform and configured to move the support platform between the plurality of locations within the interior region.

4. The automated sample fluid collection system of claim 1, further comprising a scanner configured to scan a identifier positioned on the sample vessel, the identifier associated with information stored in a database of a sample vessel identifier system.

5. The automated sample fluid collection system of claim 4, wherein the scanner is configured to identify at least one of a barcode or an RFID tag.

6. The automated sample fluid collection system of claim 4, wherein the information stored in the database includes one or more of a material from which the sample vessel is constructed, a type of sample suitable for use with the sample vessel, a type of sample unsuitable for use with the sample vessel, and a cleanliness status of the sample vessel.

7. The automated sample fluid collection system of claim 4, wherein the sample probe is configured to prevent dispensing of fluid from the fluid sample source into the vessel base if the identifier does not correspond to a sample type available to the sample probe.

8. The automated sample fluid collection system of claim 1, wherein the uncapper includes an uncapper head rotatably coupled to an uncapper housing.

9. The automated sample fluid collection system of claim 8, wherein the uncapper housing supports a motor configured to rotate the uncapper head relative to the uncapper housing.

10. The automated sample fluid collection system of claim 8, wherein the uncapper head includes a vacuum structure configured to draw a vacuum against the cap to hold the cap within the uncapper head.

11. The automated sample fluid collection system of claim 10, wherein the uncapper includes a vacuum sensor configured to register at least one of a presence or an absence of the cap relative to the uncapper head and generate a signal in response thereto.

12. The automated sample fluid collection system of claim 11, wherein the fluid sample probe is configured to prevent dispensing of fluid from the fluid sample source into the vessel base if the signal from the vacuum sensor is indicative of an absence of the cap.

13. The automated sample fluid collection system of claim 1, further comprising a door coupled to the housing, the door configured to transition between an open configuration and a closed configuration, the open configuration permitting passage of the support platform into the interior region, the closed configuration isolating the interior region from an environment exterior to the housing.

14. An automated sample fluid collection system, comprising:
a housing defining an interior region to introduce a fluid sample to a sample vessel;
a support platform to hold the sample vessel and laterally position the sample vessel to a plurality of locations within the interior region;
a scanner configured to scan an identifier positioned on the sample vessel, the identifier associated with information stored in a database corresponding to one or more traits of the sample vessel;
an uncapper configured to automatically remove a cap of the sample vessel from a base of the sample vessel prior to introduction of the fluid sample to the base and to automatically replace the cap to the vessel base subsequent to introduction of the fluid sample to the base; and
a fluid sample probe configured to fluidically couple with a fluid sample source and to dispense fluid from the fluid sample source into the vessel base.

15. The automated sample fluid collection system of claim 14, further comprising a rinse nozzle within the interior region, the rinse nozzle configured to dispense a rinse fluid onto an external surface of the sample vessel.

16. The automated sample fluid collection system of claim 14, further comprising a motor coupled with the support platform and configured to move the support platform between the plurality of locations within the interior region.

17. The automated sample fluid collection system of claim 14, wherein the scanner is configured to identify at least one of a barcode or an RFID tag.

18. The automated sample fluid collection system of claim 14, wherein the information stored in the database includes one or more of a material from which the sample vessel is constructed, a type of sample suitable for use with the sample vessel, a type of sample unsuitable for use with the sample vessel, and a cleanliness status of the sample vessel.

19. The automated sample fluid collection system of claim 14, wherein the sample probe is configured to prevent dispensing of fluid from the fluid sample source into the vessel base if the identifier does not correspond to a sample type available to the sample probe.

20. The automated sample fluid collection system of claim 1, further comprising a door coupled to the housing, the door configured to transition between an open configuration and a closed configuration, the open configuration permitting passage of the support platform into the interior region, the closed configuration isolating the interior region from an environment exterior to the housing, wherein the sample probe is configured to dispense fluid from the fluid sample source into the vessel base when the door is in the closed configuration.
